(19) United States
(12) Patent Application Publication
(10) Pub. No.: US 2015/0330377 A1
(43) Pub. Date: Nov. 19, 2015

(54) HAND PUMP HAVING ELECTRIC GENERATOR

(71) Applicant: Beto Engineering & Marketing Co., Ltd., Taichung (TW)

(72) Inventor: Lo Pin WANG, Taichung (TW)

(73) Assignee: Beto Engineering & Marketing Co., Ltd., Taichung (TW)

(21) Appl. No.: 14/280,781

(22) Filed: May 19, 2014

(51) Int. Cl. F04B 33/00

(52) U.S. Cl. CPC F04B 33/00

(57) ABSTRACT

A hand pump includes a piston slidably engaged in a housing and coupled to a piston rod, a handle attached to the piston rod for moving the piston along the housing in the reciprocating action in order to pump and generate a pressurized air and to supply the pressurized air out through the outlet port of the housing, and an electric generator is engaged in the housing for being actuated and operated by the pressurized air to generate an electrical energy. The electric generator includes a fan device for being actuated and operated by the pressurized air, and includes a rotor engaged in a coil for generating the electrical energy when the rotor is rotated relative to the coil.

### BACKGROUND OF THE INVENTION

1. Field of the Invention

The present invention relates to a hand pump or air pump, and more particularly to a hand pump or air pump including an electric or electrical generating mechanism for suitably generating an electrical energy while the user is actuating or operating the hand pump, and for suitably supplying the electrical energy to energize various electrical facilities.

2. Description of the Prior Art

Typical hand pumps or air pumps comprise a tubular or cylindrical housing including a stand, such as a foldable or collapsible stand attached or mounted or secured to the bottom portion thereof for supporting the tubular or cylindrical housing in or at an upright status, and a handle, such as a foldable or collapsible handle attached or mounted or secured to the upper portion thereof for actuating or operating the piston to slide or to move in a reciprocating action within the tubular or cylindrical housing in order to pump or to force and to generate the pressurized air and to supply the pressurized air out of the tubular or cylindrical housing.

For example, U.S. Pat. No. 2,576,687 to Krehbiel, U.S. Pat. No. 3,907,461 to Bouder, U.S. Pat. No. 4,334,839 to Flagg, U.S. Pat. No. 5,683,234 to Chuang et al., U.S. Pat. No. 6,485,264 to Wu, U.S. Pat. No. 6,558,129 to Wang, and U.S. Pat. No. 7,331,768 to Wu disclose several of the typical hand pumps or air pumps each comprising a tubular or cylindrical housing including a bottom stand or base, and a foldable or collapsible handle attached or mounted or secured to the upper portion thereof for actuating or operating the piston to move in a reciprocating action within the tubular or cylindrical housing in order to pump and to generate a pressurized air to inflate various objects, such as balls, tires and the like.

However, the reciprocating action between the piston and the tubular or cylindrical housing may only be used to generate the pressurized air, but may not be used to generate the electrical energy.

The present invention has arisen to mitigate and/or obviate the afore-described disadvantages of the conventional hand pumps or air pumps.

### SUMMARY OF THE INVENTION

The primary objective of the present invention is to provide a hand pump or air pump including an electric or electrical generating mechanism for suitably generating an electrical energy while the user is actuating or operating the hand pump, and for suitably supplying the electrical energy to energize various electrical facilities.

In accordance with one aspect of the invention, there is provided a hand pump comprising a housing including a chamber formed therein, and including an outlet port provided therein, a piston slidably received and engaged in the chamber of the housing and movable along the chamber of the housing in a reciprocating action in order to pump and generate a pressurized air and to supply the pressurized air out through the outlet port of the housing, a piston rod including an inner end portion attached to the piston for actuating the piston to move along the chamber of the housing in the reciprocating action, and including an outer end portion extendible out of the housing, and an electric generator engaged in the chamber of the housing for being actuated and operated by the pressurized air to generate an electrical energy and to energize various electrical facilities.

The electric generator includes a fan device for being actuated and operated or rotated by the pressurized air. The electric generator includes a coil, and a rotor engaged in the coil and coupled to the fan device for generating the electrical energy when the rotor is rotated relative to the coil by or with the fan device by the pressurized air.

The electric generator is preferably disposed within the housing and disposed or located close to the outlet port of the housing for being effectively actuated and operated by the pressurized air. The housing includes an electric storage mechanism, such as a battery or the like electrically connected to the electric generator for storing the electric energy generated by the electric generator.

The housing includes an interface electrically connected to the electric generator. The housing includes a foot stand, and the interface is mounted in the foot stand of the housing for electrically connecting or coupling to various electrical facilities with an electric wire or cable and for supplying the electrical energy to energize the electrical facilities.

The housing includes a cap attached to an upper end portion of the housing, and the cap includes a bore formed therein and communicating with the chamber of the housing for slidably receiving and engaging with the piston rod and for anchoring the piston rod to the housing.

The housing includes a hose connected to the outlet port of the housing for receiving the pressurized air from the housing, and includes a nozzle coupled to the hose for engaging with various kinds of air inflatable facilities or devices and for filling or supplying the pressurized air to inflate the inflatable facilities or devices.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an partial exploded view of a hand pump or air pump in accordance with the present invention;

FIG. 2 is a perspective view of the hand pump or air pump, in a folded or storing structure or status or position;

FIG. 3 is another perspective view similar to FIG. 2, illustrating the actuating or operation of the hand pump or air pump;

FIG. 4 is a partial cross sectional view of the hand pump or air pump;

FIG. 5 is another partial cross sectional view similar to FIG. 4, illustrating the actuating or operation of the hand pump or air pump;

FIG. 6 is a further partial cross sectional view illustrating the electrical generating mechanism of the hand pump or air pump; and

FIG. 7 is a block diagram illustrating the actuating or operation of the hand pump or air pump.

### DETAILED DESCRIPTION OF THE PREFERRED EMBODIMENT

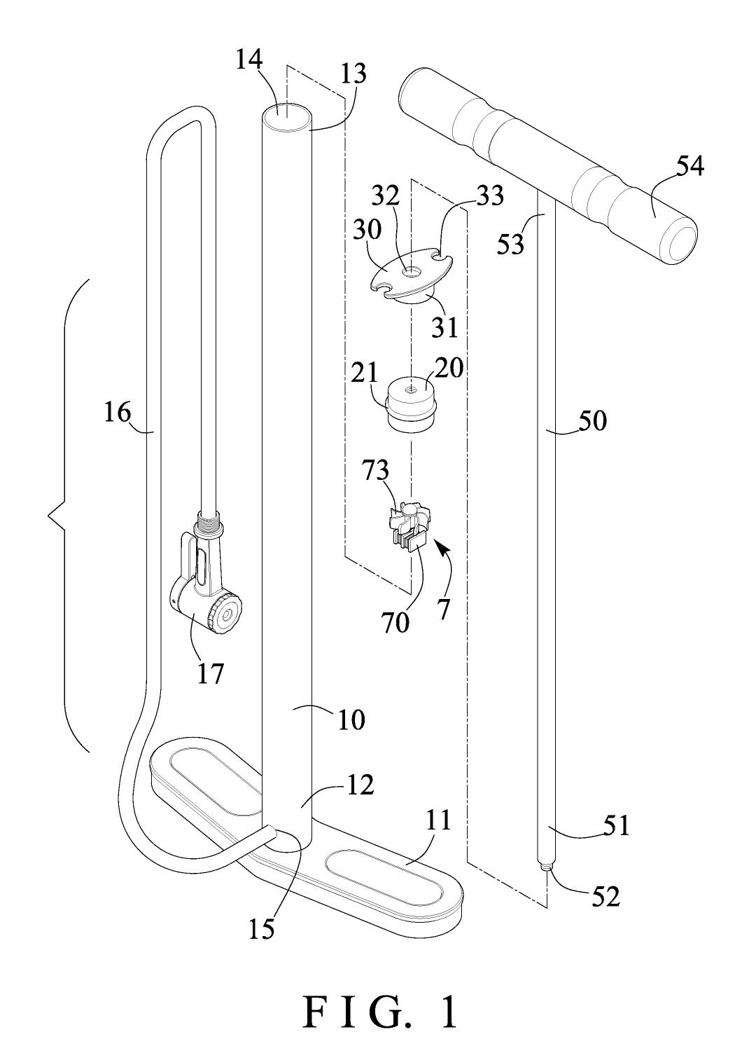

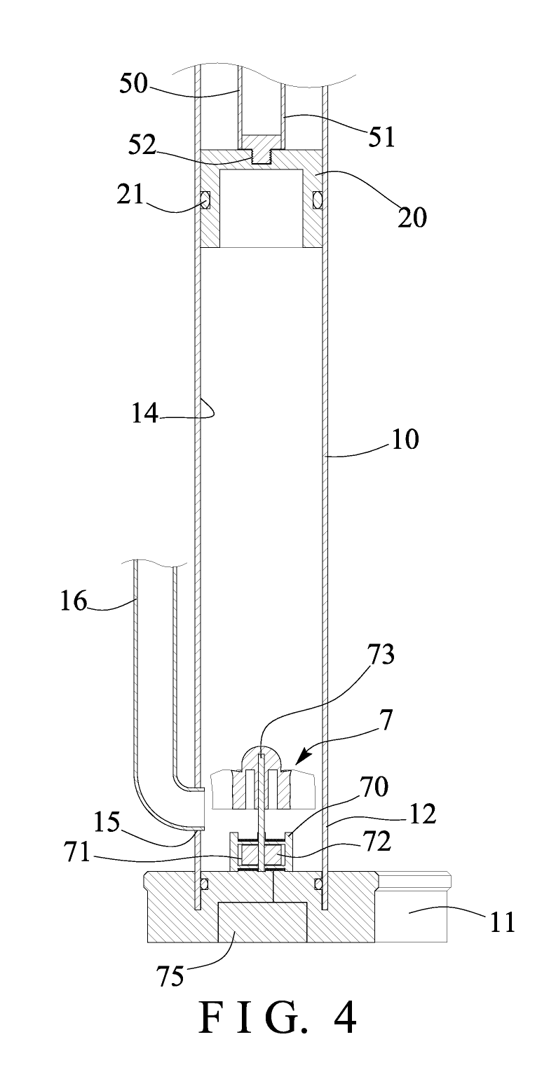

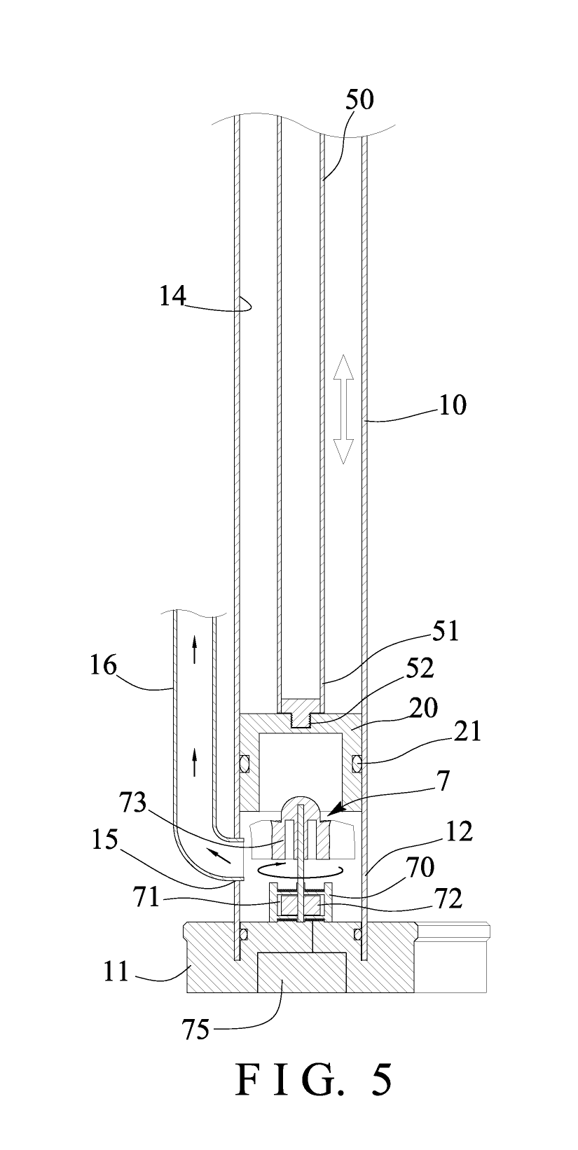

Referring to the drawings, and initially to FIGS. 1-4, a hand pump or air pump in accordance with the present invention comprises a tubular or cylindrical housing 10 including a foot stand 11, such as a foldable or collapsible or stable or solid foot stand 11 attached or mounted or secured to the bottom or lower portion or one or first end portion 12 of the housing 10, for supporting the housing 10 in or at an upright status or working position, and the housing 10 includes an opened upper portion or other or second end portion 13, and includes a compartment or chamber 14 formed therein (FIGS. 4-5) for slidably receiving or engaging with a piston 20.

The housing 10 includes an exit or outlet port 15 formed or provided in the other or second end portion 13 of the housing 10 for air outwardly flowing or discharging purposes. For example, the housing 10 includes a hose 16 connected or coupled to the outlet port 15 of the housing 10 for receiving the pressurized air from the housing 10, and includes a tap or mouth or nozzle 17 attached or mounted or secured or coupled to the hose 16 for engaging with various kinds of air inflatable facilities or devices (not shown) and for filling or supplying the pressurized air to inflate the inflatable facilities or devices (FIG. 5).

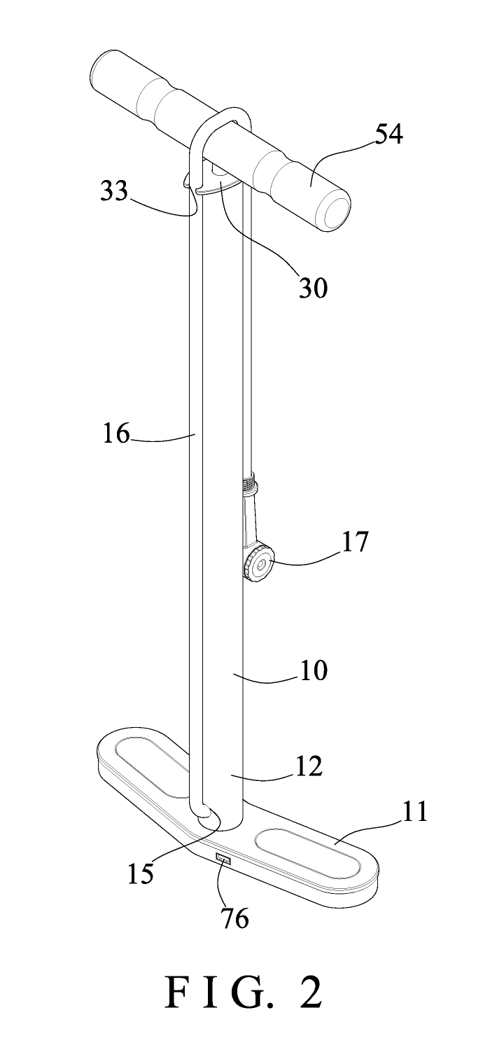

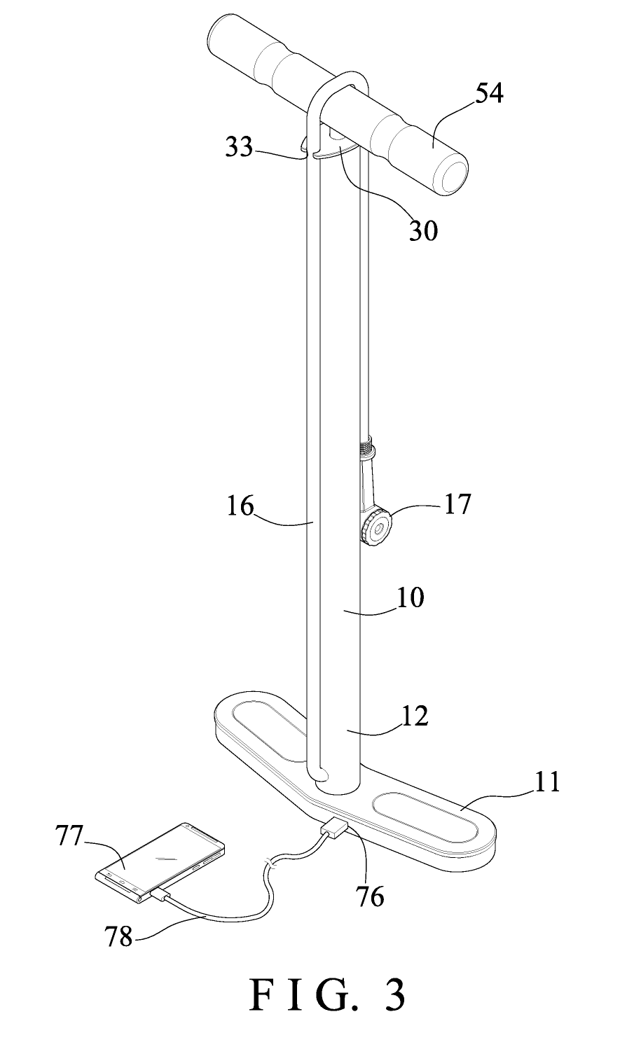

The housing 10 further includes a cap 30 attached or mounted or secured or engaged onto the other or second end portion or the upper portion 13 of the housing 10 with such as a threading engagement 31 or the like for enclosing or blocking the other or second end portion or the upper portion 13 of the housing 10, the cap 30 includes a compartment or bore 32 formed therein (FIG. 1) and communicating with the chamber 14 of the housing 10, and the cap 30 includes one or more (such as two) depressions or recesses or notches 33 formed in the cap 30 for selectively receiving or engaging with the hose 16 and for storing or for organizing the hose 16 (FIGS. 2, 3).

A piston rod 50 is slidably engaged through the bore 32 of the cap 30 or of the housing 10, and includes a first or one end or inner end portion 51 attached or mounted or secured to the piston 20 with such as a threading engagement 52, for actuating or operating the piston 20 to move along the chamber 14 of the housing 10 in a reciprocating action (FIGS. 4, 5) in order to pump and to generate the pressurized air and to supply the pressurized air out through the outlet port 15 of the housing 10 and the nozzle 17, and includes a second or outer end portion 53 extended out of the other or second end portion 13 of the housing 10 and attached or mounted or secured or coupled to a hand grip or handle 54 which may be used or provided for actuating or operating the piston 20 to move and slide along the chamber 14 of the housing 10 in the reciprocating action.

A sealing ring 21 is attached or mounted or secured or engaged onto the piston 20 and slidably contacted or engaged with the housing 10 for making an air tight seal between the piston 20 and the housing 10. The above-described structure or configuration for the housing 10 and the piston 20 and the cap 30 and the piston rod 50 is typical and will not be described in further details. The hand pump or air pump in accordance with the present invention further comprises an electric or electrical generating device or mechanism 7 for suitably generating an electrical energy while the user is actuating or operating or pumping the hand pump, and for suitably supplying the electrical energy to energize various electrical facilities.

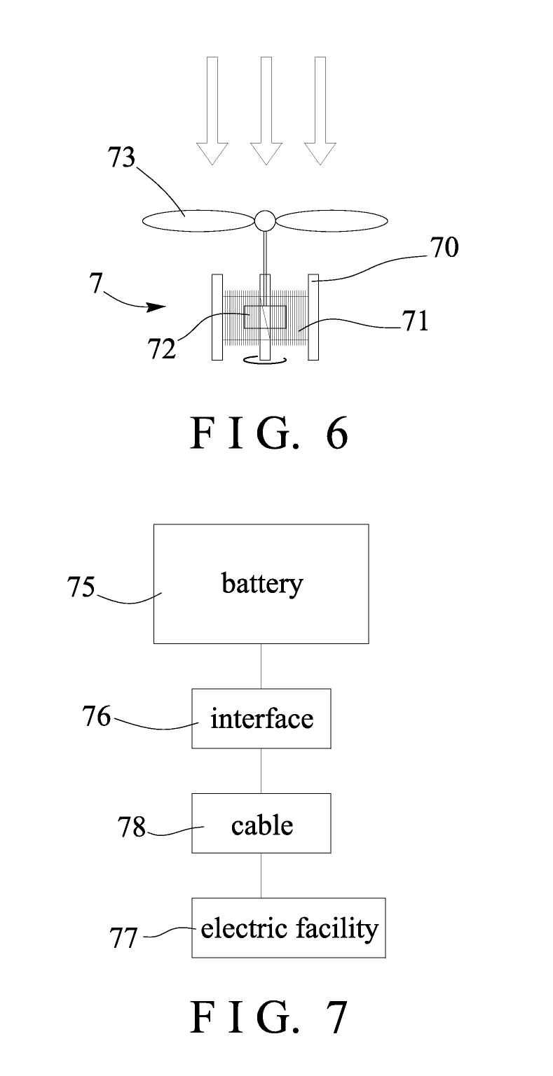

For example, as shown in FIGS. 4-6, the electrical generating mechanism 7 includes a mini-type or micro electric generator 70 attached or mounted or secured or engaged into the chamber 14 of the housing 10 and disposed or arranged or located or engaged on the foot stand 11 or the bottom wall of the housing 10, and preferable, but not necessary that the electric generator 70 is disposed or arranged or located close to the outlet port 15 of the housing 10, and the electric generator 70 includes a coil 71 and a rotor 72 which is magnetized or is made of magnetic materials or is selected from a magnetic member, such as a permanent magnetic member, and the coil 71 is disposed or arranged or located or engaged around the rotor 72 for suitably generating an electrical energy while the rotor 72 is moved or pivoted or rotated relative to the housing 10 and the coil 71.

The electrical generating mechanism 7 further includes a fan blade or fan device 73 attached or mounted or secured or connected or coupled to the rotor 72 for suitably pivoting or rotating the rotor 72 relative to the housing 10 and the coil 71 and for generating an electrical energy while the rotor 72 is pivoted or rotated relative to the housing 10 and the coil 71 by or with the pressurized air which is generated by the piston 20 that moves along the chamber 14 of the housing 10 in the reciprocating action. As shown in FIGS. 4-5, the hand pump or air pump further includes a storage mechanism or member or device 75, such as a battery 75 or the like, electrically connected or coupled to the electric generator 70 for receiving or obtaining the electrical energy form the electric generator 70 and for suitably storing and supplying the electrical energy to energize various electrical facilities.

As shown in FIGS. 2 and 7, the hand pump or air pump further includes an interface 76, such as USB, micro USB, mini USB . . . or the like attached or mounted or secured or engaged into the housing 10, such as the foot stand 11 of the housing 10 (FIG. 2), and electrically connected or coupled to the electric generator 70 (FIGS. 4, 5) and/or to the battery or storage mechanism 75 (FIG. 7) for receiving or obtaining the electrical energy form the battery or storage mechanism 75, and for electrically connecting or coupling to various electrical facilities 77 with an electric wire or cable 78, and for supplying the electrical energy to energize the electrical facilities 77.

In operation, as shown in FIGS. 4-5, when the piston 20 is actuated or operated to slide and move along the chamber 14 of the housing 10 in the reciprocating action, the pressurized air may be pumped and generated and may be supplied out through the outlet port 15 of the housing 10 and then may flow out through the nozzle 17 (FIGS. 1-3) and then into the inflatable facilities or devices. In addition, when the pressurized air is generated and supplied out through the outlet port 15 of the housing 10, the pressurized air may actuate or operate the fan device 73 to rotate the rotor 72 relative to the housing 10 and the coil 71 and to generate and supply the electrical energy to energize various electrical facilities 77 or to the battery or storage mechanism 75.

It is to be noted that the electrical energy may be directly supplied to the electrical facilities 77 from the electric generator 70 when the piston 20 is actuated or operated to slide and move along the chamber 14 of the housing 10 in the reciprocating action by the user. In addition, the electrical energy may be supplied to and stored within the battery or storage mechanism 75 which may then supply the electrical energy to the interface 76 and then to energize the electrical facilities 77 as shown in FIG. 7, such that the battery or storage mechanism 75 may be optionally provided and attached or mounted to the housing 10 and coupled to the interface 76 when required.

Accordingly, the hand pump or air pump in accordance with the present invention includes an electric or electrical generating mechanism for suitably generating an electrical energy while the user is actuating or operating the hand pump, and for suitably supplying the electrical energy to energize various electrical facilities.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hand pump comprising:
a housing including a chamber formed therein, and including an outlet port provided therein,
a piston slidably received and engaged in said chamber of said housing and movable along said chamber of said housing in a reciprocating action in order to pump and generate a pressurized air and to supply the pressurized air out through said outlet port of said housing,
a piston rod including an inner end portion attached to said piston for actuating said piston to move along said chamber of said housing in the reciprocating action, and including an outer end portion extendible out of said housing, and
an electric generator engaged in said chamber of said housing for being actuated and operated by the pressurized air to generate an electrical energy.

2. The hand pump as claimed in claim 1, wherein said electric generator includes a fan device for being actuated and operated by the pressurized air.

3. The hand pump as claimed in claim 2, wherein said electric generator includes a coil, and a rotor engaged in said coil and coupled to said fan device for generating the electrical energy when said rotor is rotated relative to said coil with said fan device.

4. The hand pump as claimed in claim 1, wherein said electric generator is disposed and located close to said outlet port of said housing.

5. The hand pump as claimed in claim 1, wherein said housing includes a storage mechanism electrically connected to said electric generator.

6. The hand pump as claimed in claim 1, wherein said housing includes an interface electrically connected to said electric generator.

7. The hand pump as claimed in claim 6, wherein said housing includes a foot stand, and said interface is mounted in said foot stand of said housing.

8. The hand pump as claimed in claim 1, wherein said housing includes a cap attached to an upper end portion of said housing, and said cap includes a bore formed therein and communicating with said chamber of said housing for slidably receiving and engaging with said piston rod.

9. The hand pump as claimed in claim 1, wherein said housing includes a hose connected to said outlet port of said housing for receiving the pressurized air from said housing, and includes a nozzle coupled to said hose.
